(19) United States
(12) Patent Application Publication
(10) Pub. No.: US 2021/0103899 A1
(43) Pub. Date: Apr. 8, 2021

(54) WASTE MANAGEMENT SYSTEM AND METHOD

(71) Applicant: MASTERCARD INTERNATIONAL INCORPORATED, Purchase, NY (US)

(72) Inventors: Randhir KUMAR, Samastipur (IN); Ashutosh GUPTA, Varanasi (IN); Dinesh Kumar LAL, Gurgaon (IN)

(21) Appl. No.: 16/499,725

(22) PCT Filed: Feb. 8, 2018
(86) PCT No.: PCT/US2018/017346

§ 371 Date: Sep. 30, 2019

(30) Foreign Application Priority Data
Mar. 31, 2017 (SG) 10201702681

(51) Int. Cl. G06Q 10/00; G06Q 30/02

(52) U.S. Cl. CPC G06Q 10/30; G06Q 30/0201

(57) ABSTRACT

A method for use in scheduling waste services, the method including, in at least one processing device, obtaining transaction details indicative of transactions between consumers and merchants, using the transaction details to determine predicted waste volumes within each of a number of geographic areas and generating waste data indicative of the predicted waste volumes in each geographic area, the waste data being used in scheduling waste services.

### CROSS-REFERENCE TO RELATED APPLICATIONS

This application is the U.S. National Stage Application of International Application No. PCT/US2018/017346, filed Feb. 8, 2018, which claims the benefit of, and priority to, Singapore Patent Application No. 10201702681R filed on Mar. 31, 2017. The entire disclosure of the above applications are incorporated herein by reference.

### TECHNICAL FIELD

The present invention relates to a system and method for waste management, and in particular to a system and method for waste management based at least partially on details of purchases between a consumer and merchant.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavor to which this specification relates.

Collection of waste, particularly in urban environments, can be problematic. In particular waste departments typically have to empty rubbish bins or other refuse receptacles sufficiently often to ensure these do not become overfilled. Emptying is typically scheduled on a regular periodic basis, such as daily or weekly, with the frequency being set based on an availability of resources and typical waste levels. However, this means bins are often emptied more frequently than required, leading to unnecessary activity by the waste department, which in turn has an associated cost. Additionally, in circumstances where more than usual amounts of waste are created, this can lead to bins become full in advance of the next scheduled emptying, which can lead to waste accumulation, which can in turn result in health or other related hazards.

### BRIEF SUMMARY

In one broad form an aspect of the present invention seeks to provide a method for use in scheduling waste services, the method including, in at least one processing device: obtaining transaction details indicative of transactions between consumers and merchants; using the transaction details to determine predicted waste volumes within each of a number of geographic areas; and, generating waste data indicative of the predicted waste volumes in each geographic area, the waste data being used in scheduling waste services.

In one broad form an aspect of the present invention seeks to provide a system for use in scheduling waste services, the system including at least one processing device that: obtains transaction details indicative of transactions between consumers and merchants; uses the transaction details to determine predicted waste volumes within each of a number of geographic areas; and, generates waste data indicative of the predicted waste volumes in each geographic area, the waste data being used in scheduling waste services.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:

FIG. 1 is a flow chart of an example of a process for use in scheduling waste services;

FIG. 2 is a schematic diagram of an example of a distributed computer architecture;

FIG. 3 is a schematic diagram of an example of a processing system;

FIG. 4 is a schematic diagram of an example of a transaction terminal;

FIG. 5 is a schematic diagram of an example of a computer system;

FIG. 6 is a flow chart of an example of a clustering processing; and,

FIGS. 7A to 7C are a flow chart of a specific example of a process for scheduling waste services.

### DETAILED DESCRIPTION

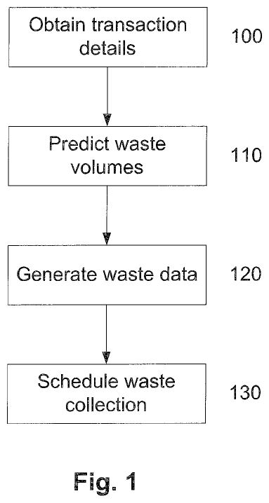

An example of a process for use in scheduling waste services will now be described with reference to FIG. 1.

For the purpose of this example, it is assumed that the process is performed at least in part utilizing one or more processing devices. The one or more processing devices can form part of one or more processing systems, such as one or more servers, computer systems or the like and may form part of a payment network backend, or similar. Whilst reference may be made generally to a single processing device in the remainder the description, this is for the purpose of ease of explanation only and it will be appreciated that in practice functionality could be distributed across multiple processing devices, for example forming part of different processing systems, and the term should not therefore be considered as limiting.

For the purpose of illustration, the term “consumer” is intended to refer to any entity, including an individual, group of individuals, company, partnership or other organization, involved in acquiring one or more products or services, whilst the term “merchant” refers to any entity, including an individual, group of individuals, company, partnership or other organization that is involved in supplying goods or services. It will therefore be appreciated that these terms are not intended to be limiting.

In this example, at step 100 transaction details, indicative of transactions between consumers and merchants, are obtained. The transaction details can be of any appropriate form, and could include information regarding an identity of a customer or merchant, details of a customer account and a transaction amount, such as a payment amount to be paid from the customer account to the merchant. However, this is not intended to be restrictive and other transaction details could be used, such as an indication of items purchased or the like. Whilst the transaction details may be obtained in any one of a number of manners, such as retrieving details of transaction from a database containing transaction details, or the like, more typically the transaction details are received by the processing device as part of a payment process. For example, the processing device could form part of a payment network backend, and receive transaction details created by a transaction terminal or other payment device, in order to allow a payment from the consumer to the merchant to be processed. It will therefore be appreciated that the transaction details may form part of pre-approval data, used for approving the transaction, or could be batch data used in subsequently processing the transaction as part of a batch of transactions, and that both of these examples are assumed to be within the scope of the current disclosure.

At step 110 transaction details relating to one or more transactions are used to predict waste volumes in a number of geographic areas. In particular, the transaction details are analyzed in order to make an assessment of the likely amount of waste in a given geographic area resulting from the transactions. For example, when goods are purchased, these are often associated with packaging, which is then disposed of and similarly single use items may be disposed of following use, meaning that knowledge of purchase of items can be used to anticipate waste that might result.

Whilst predicting waste volumes would ideally be performed based on information regarding specific items purchased, this information is not always available. Accordingly, this process typically involves examining attributes of the transactions, such as a transaction spend, a merchant identity, a location of the transaction, consumer or merchant, or the like, and using these to predict a waste amount. Thus, the assessment can take into account information such as the type of items that might be purchased and/or a value of the purchase to predict an amount of waste that might be associated with a transaction. This can then be used together with information regarding a location, such as a location of the transaction or consumer, to associate the waste amount with a particular geographic area, thereby predicting the waste volumes on an area by area basis. As will be described in more detail below, in practice this can be achieved using a multivariate analysis of available transaction details and optionally other information.

At step 120 predicted waste volumes are utilized in order to generate waste data indicative of the waste volumes for respective geographic areas, which can then be used in scheduling waste services at step 130. In particular, based on information regarding available waste receptacles within the one or more geographical areas, the predicted waste volumes can be utilized in order to predict when the waste receptacles will be filled and hence schedule waste services, allowing the waste to be collected shortly before the receptacles fill.

It will be appreciated that in one example, the process of predicting waste levels and then scheduling waste services might be performed by different entities. For example, as the prediction of waste levels is performed based on transaction details, in one example this is performed by an entity involved in the transaction process, such as a payment network provider, whereas the scheduling of waste services requires knowledge of waste receptacle and waste service availability and hence might be performed by a third party, such as a waste department. Accordingly, in one example the payment network provider creates the waste data, making this available to the waste department, allowing them to perform the scheduling of waste services. However, this is not essential, and it will be appreciated that in another example, the prediction of waste levels and scheduling of services can be performed by a single entity.

In any event, the above-described process utilizes information regarding transactions being performed in order to more reliably predict waste volumes. As this predication is based on actual transaction details, as opposed to historical information regarding rubbish collection requirements, this allows waste volumes to be predicted more accurately which can in turn result in more accurate scheduling of waste services. This in turn reduces the amount of unnecessary waste collection processes that are performed, whilst ensuring that waste receptacles are emptied in a timely fashion so as to prevent accumulation of waste.

A number of further features will now be described.

The process of predicting the waste levels can be performed in variety of different manners, depending on the preferred implementation and the amount of information available. In one example, the transaction details are indicative of a transaction amount and the method includes determining the predicted waste levels using the transaction amount. Thus as a first estimation, the amount of waste could be estimated purely on the basis of a transaction amount, so that higher transaction amounts would be correlated with additional waste volumes. It will be appreciated however that this could be inaccurate as different types of transactions, and in particular purchase of different types of items, may lead to different waste volumes.

Accordingly, in a further example, the transaction details are also indicative of a merchant and the method includes determining the predicted waste levels using an indication of the merchant obtained from the transaction details. In this regard, each merchant can be associated with a respective industry type, such as commercial products, consumable products, food, clothing, white goods, machinery supply, or the like, so that the industry type of the merchant can be determined. Following this an industry waste level for the respective industry type can be obtained, with the industry waste level representing an average waste volume associated with a given transaction amount. The industry waste level can then be used to determine the predicted waste levels for the respective transaction. Thus, in this example, the calculation takes into account the typical amount of waste for a given transaction amount for the respective type of industry with which the merchant is associated.

The industry waste level can be determined in any suitable manner, such as by retrieving this from a suitable database. In one example, the industry waste level calculated by analyzing merchant sales data indicative of historical sales of items by merchants of respective industry type to thereby determine item sale patterns. Following this, the item sale patterns are used together with item data indicative of a waste amount associated with each of a plurality of different types of items, to determine the industry waste amount for a merchant of the respective type. Alternatively, the industry waste level can be determined from an analysis of historical waste volumes for the respective industry, for example by establishing a correlation between transaction amounts and resulting waste volumes for the respective industry.

Accordingly, the above described techniques use information regarding a transaction amount and the industry to which the transaction relates to more accurately predict the waste levels for a particular transaction. However, in a further example, the method can include further increasing prediction accuracy by determining item purchase data indicative of a purchased item and then determining the predicted waste levels at least in part using the item purchase data. In particular, the item purchase data can be indicative of an item identity or item type, with this being used to determine predicted waste levels using item waste data that specifies a waste amount associated with each of a plurality of items or item types. The item purchase data can be obtained from a number of different sources depending on the implementation. For example, the item purchase data may be obtained from the transaction details if available, or could be obtained from other sources, such as from the merchants, from suppliers of the merchants, from industry analysts, or the like. Thus, it will be appreciated that the item purchase data could be provided on a per transaction basis, or alternatively could be provided to cover a plurality of transaction, such as providing information regarding the entire stock sold by a merchant on a particular day. Irrespective of how the information is obtained, it will be appreciated that this approach can lead to more accurate predictions as this is based information regarding levels of waste associated with actual purchased items.

It will also be appreciated that in practice there are different types of waste that might need to be handled differently. For example, some types of waste may result in different volumes, whilst some types of waste, such as recycling, may need to be placed in different receptacles to more general rubbish. Accordingly, in one example, the method can include determining a predicted waste type and then determining the waste volume in one or more geographic areas using the predicted waste type, with this optionally including determining a predicted waste amount and then using the waste amount and the predicted waste type to determine the predicted waste volume. Additionally, this allows waste to be categorized which in turn allows an analysis of the predicted filling of different types of waste receptacle to be performed. In one example, the waste can be categorized into a number of different types of waste including biodegradable, non-biodegradable, recyclable, glass, paper, plastic or the like.

As previously mentioned, the analysis of waste is typically performed for different geographical areas. Accordingly, in one example, the method includes determining a predicted waste location and determining the waste volumes in one or more geographic areas using the predicted waste location. The predicted waste location can be determined in a wide range of manners and can include, for example, examining a merchant location of the merchant or a customer location of the customer, such as a billing or delivery address. This could also be based on travel patterns and/or disposal patterns of customers. For example, for certain industries such as fast food industries, it is typical for packaging to be disposed of within a short distance of the purchase location. In contrast, for other items such as supermarket shopping, it is more typical for packaging to be disposed of at or near a consumer's home. Additionally, travel patterns, such as commuting patterns, can influence where waste will be disposed of Accordingly, examining travel and consumption patterns can be used to determine a likely location of the resulting waste, in turn allowing the waste to be assigned to a respective geographical area.

It will be appreciated that a wide range of different parameters can be taken into account when determining a waste volume for a given geographic area. Accordingly, in one example, the method includes determining waste volumes using a multivariate time series analysis. The analysis is typically performed in respect of a geographic area and is performed taking into account an amount of spend by industry type, purchased items, buying behavior of consumers and a time pattern of purchase behavior. It will be appreciated from this that the system analysis historical data collected over time and utilizes this in order to predict waste volumes. This can be performed in any appropriate manner but in one example is performed using a vector autoregression model. This analysis can take into account data acquired from any one or more of transaction details, big data analytics and remote data sources.

In one preferred example, the at least one processing device is part of a payment network processing device and in particular part of a payment authorization network that includes an acquirer, an issuer, a payment network processor and a communications network. In this regard, by having the processing device forming part of a payment network enables the processing device to gain access to transaction data from a wide range of different transactions, making it more straightforward for the processing device to accurately predict waste levels. For example, this allows transaction details to be obtained from point of sales terminals, merchant processing devices or the like. In one particular example, the transaction details are received from multiple acquirers associated with a range of different merchants, with the transaction details being aggregated for analysis. This also allows the process to take into account transactions that have performed in an online environment, for example allowing predictions to be made of packaging from items delivered to a consumer's location.

Once the waste data and in particular the predicted waste volumes have been established, this can then be used to schedule a waste collection time. In order to do this, the method typically includes determining an available waste receptacle volume in the geographic area, using the available waste receptacle volume and the waste volumes to determine a predicted receptacle fill time and then using the predicted receptacle fill time to schedule the waste collection time. The available waste receptacle volume is typically based on a number of waste disposal bins, a size of waste disposal bins and/or type of waste disposal bin.

This could be performed generically for all waste but more typically is performed taking into account available waste receptacle volume for different types of waste, a predicted waste volume for different types of waste, using this information to determine a predicted receptacle fill time for different types of waste receptacles. Accordingly, in one example, waste receptacle volume is based on a number of waste disposal bins, a size of waste disposal bins and type of waste disposal bin.

To more accurately determine a likely fill time, in one example, the method includes determining an available waste receptacle volume in a geographic area based on a known receptacle volume and a duration since the receptacles were last emptied, optionally taking into account an analysis of when the receptacles are high or almost full. It will be appreciated however that this could be determining in other appropriate manners.

Additionally, the method can take into account the length of time it will take for a waste collection service to reach one or more receptacles so that a waste collection time is determined which is indicative of the time in which a waste collection service should depart from a waste department premises to commence the waste collection. This can involve determining the travel time indicative of a time of travel from a waste collection facility to a geographic area and then using the receptacle fill time and the travel time to schedule the waste collection time. The travel time can be determined taking into account factors such as a distance of travel, a type of vehicle used to perform waste collection, a waste collection rate, or predicted amount of traffic present at the time of waste collection.

As previously mentioned, the above-described process can be performed for one or more geographic areas. This is typically achieved by grouping waste receptacles into respective areas based on number of receptacles and optionally taking into account other factors such as a geographic location of each of the receptacles, a geographical location of waste disposal resources, a population density, a household income, a presence of industry and/or major industries or other demographic factors. The grouping can be performed in a variety of ways but in one example is performed using k-means clustering. Performing the grouping allows waste receptacles to be grouped into receptacles in a given geographic area that can be emptied by a waste department concurrently, which is more efficient than emptying individual receptacles.

In one example, the waste data is provided to a waste department allowing the waste department to perform scheduling. Alternatively, this could be performed by the processing device that forms part of a payment network.

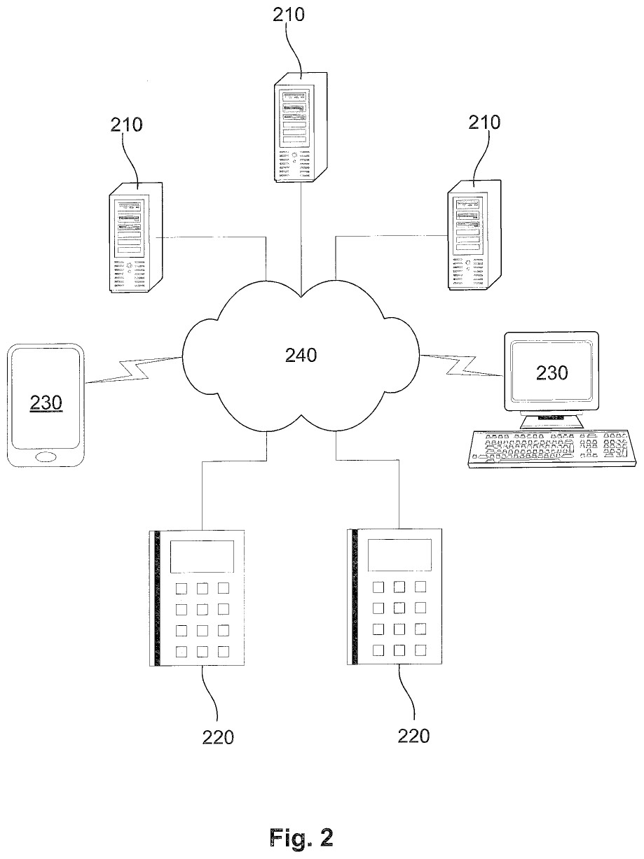

In one example, the process is performed by one or more processing systems operating as part of a distributed architecture, an example of which will now be described with reference to FIG. 2.

In this example, a number of processing systems 210 are provided coupled to one or more transaction terminals 220, and one or more client devices 230, via one or more communications networks 240, such as the Internet, and/or a number of local area networks (LANs).

The processing systems 210 are typically operated by parties, such as acquirers, payment network service providers, issuers or waste departments. It will be appreciated that any number of processing systems and similarly any number of transaction terminals 220 could be provided, and the current representation is for the purpose of illustration only. The configuration of the networks 240 is also for the purpose of example only, and in practice the processing systems 210, transaction terminals 220 and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing systems 210, are adapted to be perform various data processing tasks forming part of a transaction and/or waste collection scheduling process, and the particular functionality will vary depending on the particular requirements. Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

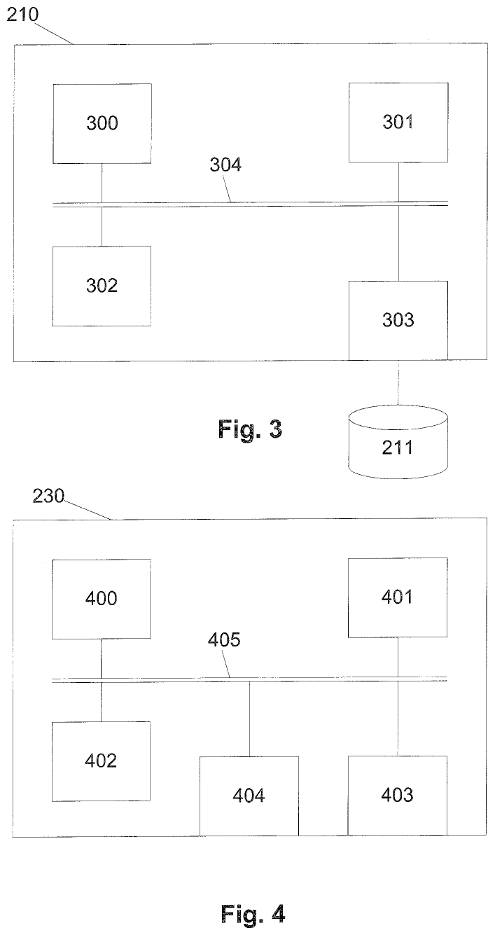

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example, the external interface 303 can be utilized for connecting the processing system 210 to peripheral devices, such as the communications networks 240, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed transaction terminal, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the transaction terminal 220 includes at least one microprocessor 400, a memory 401, an input/output device 402, such as a keyboard and/or display, an external interface 403, and typically a card reader 404, interconnected via a bus 405 as shown. In this example the external interface 403 can be utilized for connecting the transaction terminal 220 to peripheral devices, such as the communications networks 240 databases, other storage devices, or the like. Although a single external interface 403 is shown, this is for the purpose of example only, and in practice multiple interfaces using various methods (e.g. Ethernet, serial, USB, wireless or the like) may be provided. The card reader 404 can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the transaction terminals 220 may be formed from any suitable transaction terminal, and could include suitably programmed PCs, Internet terminal, lap-top, or hand-held PC, POS terminals, ATMs or the like, as well as a tablet, or smart phone, with integrated or connected card reading capabilities. However, it will also be understood that the transaction terminals 220 can be any electronic processing device such as a microprocessor, microchip processor, logic gate configuration, firmware optionally associated with implementing logic such as an FPGA (Field Programmable Gate Array), or any other electronic device, system or arrangement.

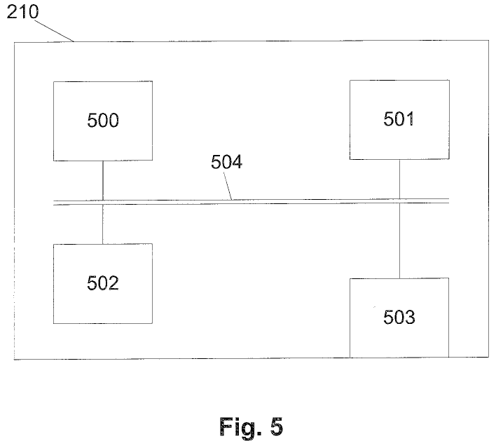

As shown in FIG. 5, in one example, the client device 230 includes at least one microprocessor 500, a memory 501, an input/output device 502, such as a keyboard and/or display, and an external interface 503, interconnected via a bus 504 as shown. In this example the external interface 503 can be utilized for connecting the client device 230 to peripheral devices, such as the communications networks 240 databases, other storage devices, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501, and to allow communication with one of the processing systems 210.

Accordingly, it will be appreciated that the client device 230 be formed from any suitably programmed processing system and could include suitably programmed PCs, Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for scheduling waste services will now be described in further detail. For the purpose of these examples it is assumed that one or more respective processing systems 210 are servers that provide functionality required of a payment network service provider and a waste department, with users or operators interacting with these via a respective client device 230. The servers 210 typically execute processing device software, allowing relevant actions to be performed, with actions performed by the server 210 being performed by the processor 300 in accordance with instructions stored as applications software in the memory 301 and/or input commands received from a user via the I/O device 302. It will also be assumed that actions performed by the transaction terminal 220, are performed by the processor 400 in accordance with instructions stored as applications software in the memory 401 and/or input commands received from a user via the I/O device 402, whilst actions performed by the client device 230 are performed by the processor 510 in accordance with instructions stored as applications software in the memory 504 and/or input commands received from a user via the user controls 514.

However, it will be appreciated that the above described configuration assumed for the purpose of the following examples is not essential, and numerous other configurations may be used. It will also be appreciated that the partitioning of functionality between the different processing systems may vary, depending on the particular implementation.

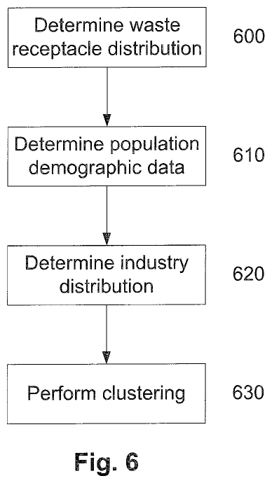

An example of a clustering process performed to identify respective geographic areas will now be described with reference to FIG. 6. For the purpose of this example, it is assumed that this is performed by a payment network service provider server 210, optionally operating under control of an operator using a client device 230 or other server 210.

In this example, at step 600 a waste receptacle distribution is determined. This information is typically available from the waste services department, and may for example be obtained by requesting the information from a waste services department server 210.

At step 610 a population demographic data is determined, for example by retrieving this from a suitable database, requesting the information from government records, or the like. The population demographic data is indicative of a relative distribution of population and additionally other demographic information such as an income distribution or the like. An industry distribution is determined at step 620, with this being obtained from a suitable source, such as an industry analyst, government department or the like.

Once the relevant information has been determined, clustering is performed in order to group the receptacles based on the location and the receptacle's likely use to thereby identify the geographic areas at step 630. This is typically achieved using k-means clustering approach, which is a method of vector quantization, originally from signal processing, that is popular for cluster analysis in data mining. k-means clustering aims to partition n observations into k clusters in which each observation belongs to the cluster with the nearest mean, serving as a prototype of the cluster. This results in a partitioning of the data space into Voronoi cells.

Given a set of observations (x₁, x₂, . . . , xₙ), where each observation is a d-dimensional real vector, k-means clustering aims to partition the n observations into k(≤n) sets S={S₁, S₂, . . . , Sₖ} so as to minimize the within-cluster sum of squares (WCSS) (sum of distance functions of each point in the cluster to the K center). In other words, its objective is to find:

$${arg min}_{S} {\sum }_{i = 1}^{k} {\sum }_{x ∈ {S}_{i}} {‖ x - {μ}_{i} ‖}^{2}$$

where μᵢ is the mean of points in Sᵢ.

The most common algorithm uses an iterative refinement technique. Due to its ubiquity it is often called the k-means algorithm; it is also referred to as Lloyd's algorithm, particularly in the computer science community.

Given an initial set of k-means m₁⁽¹⁾, . . . , mₖ⁽¹⁾ (see below), the algorithm proceeds by alternating between two steps:

Assignment step: Assign each observation to the cluster whose mean yields the least within-cluster sum of squares (WCSS). Since the sum of squares is the squared Euclidean distance, this is intuitively the “nearest” mean. (Mathematically, this means partitioning the observations according to the Voronoi diagram generated by the means).

Sᵢ^{(t)}={xₚ:∥xₚ−mᵢ^{(t)}∥²≤∥xₚ−mⱼ^{(t)}²∀j, 1≤j≤k},

where each xₚ assigned to exactly one S^{(t)}, even if it could be assigned to two or more of them.

Update step: Calculate the new means to be the centroids of the observations in the new clusters.

$${m}_{i}^{( t + 1 )} = \frac{1}{\vert {S}_{i}^{( t )} \vert} {\sum }_{{x}_{j} ∈ {S}_{i}^{( t )}} {x}_{j}$$

Since the arithmetic mean is a least-squares estimator, this also minimizes the within-cluster sum of squares (WCSS) objective. The algorithm has converged when the assignments no longer change. Since both steps optimize the WCSS objective, and there only exists a finite number of such partitionings, the algorithm must converge to a (local) optimum.

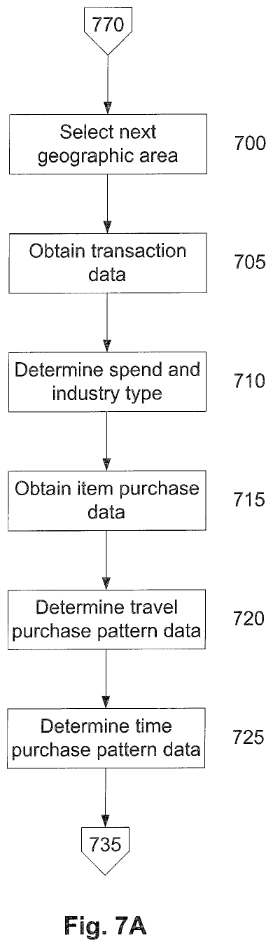

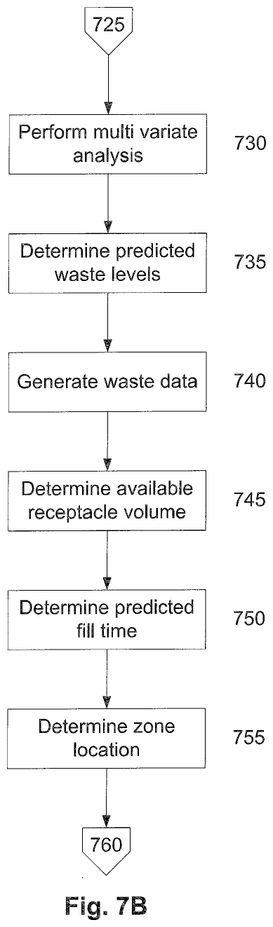

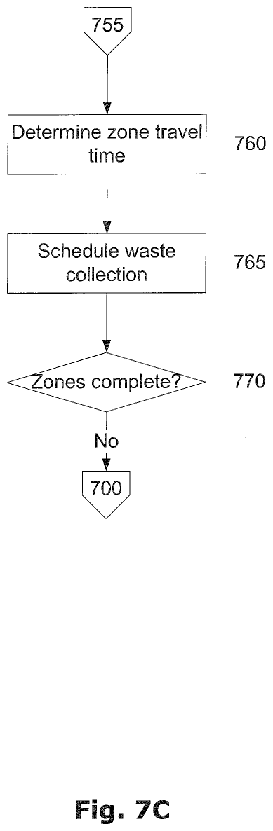

Having determined a cluster of receptacles, this can then be used to define the respective geographic areas, for example defining an area encompassing a group of receptacles, with the groups then being used for scheduling collection of waste using the process that will now be described in further detail with reference to FIGS. 7A to 7C.

In this example, at step 700 the server 210 selects a next geographic area, before obtaining transaction data for the area at step 705. In this regard, it will be appreciated that the prediction of waste volumes and hence scheduling of waste services, can be performed on a periodic basis, such as on a daily or hourly basis, with transaction data since the last update being stored and subsequently retrieved for analysis as required.

At step 710 the server 210 analyses the transaction data to determine a transaction amount and associated industry type for each transaction, typically determining the industry type based on an identity of the merchant. Any available item purchase data is obtained at step 715, typically from merchants, or a market analyst such as a retail consultant or similar.

Travel purchase pattern data is obtained at step 720, typically through an analysis of transaction addendum data, with this being used to determine typical travel patterns, particularly focusing on movement of customers after particular purchases have been made. For example, by examining the locations of sequences of transactions for a given user, the server 210 can identify particular travel patterns, such as the user travelling to a certain location after shopping. Similarly, at step 725 time purchase pattern data is examined to identify patterns in the timing of particular purchases, such as purchasing of food at meal times.

At step 730 a multivariate time series analysis is performed in order to determine predicted waste levels within the geographic area at step 735. In one example, the multivariate time series uses a vector autoregression (VAR), which is an econometric model used to capture the linear interdependencies among multiple time series. VAR models generalize the univariate autoregressive model (AR model) by allowing for more than one evolving variable. All variables in a VAR are treated symmetrically in a structural sense (although the estimated quantitative response coefficients will not in general be the same); each variable has an equation explaining its evolution based on its own lags and the lags of the other model variables. VAR modeling does not require as much knowledge about the forces influencing a variable as do structural models with simultaneous equations: The only prior knowledge required is a list of variables which can be hypothesized to affect each other intertemporally.

A VAR model describes the evolution of a set of k variables (called endogenous variables) over the same sample period (t=1, . . . , T) as a linear function of only their past values. The variables are collected in a k×1 vector yₜ, which has as the i^{th} element, y_{i,t}, the observation at time “t” of the i^{th} variable. For example, if the i^{th} variable is GDP, then y_{i,t} is the value of GDP at time t.

A p-th order VAR, denoted VAR(p), is

yₜ=c+A₁yₜ₋₁+A₂yₜ₋₂+ . . . +Aₚyₜ₋ₚ+eₜ,
where the l-periods back observation yₜ₋₁ is called the l-th lag of y, c is a k×1 vector of constants (intercepts), Aᵢ is a time-invariant k×k matrix and eₜ is a k×1 vector of error terms satisfying
1. E(eₜ)=0—every error term has mean zero;
2. E(eₜe′ₜ)=Ω—the contemporaneous covariance matrix of error terms is Ω (a k×k positive-semidefinite matrix);
3. E(eₜe′ₜ₋ₖ)=0 for any non-zero k—there is no correlation across time; in particular, no serial correlation in individual error terms.^{[1]}

A pth-order VAR is also called a VAR with p lags. The process of choosing the maximum lag p in the VAR model requires special attention because inference is dependent on correctness of the selected lag order.

In a preferred example, the ideal time for waste cleaning will be identified utilizing the listed four factors above as individual time series and will be used as dependent variable in multivariate time series model.

At step 740, the server 210 generates waste data indicative of the predicted waste levels, which can then be used to allow the waste schedule to be determined. This can be performed by the payment network provider server 210, or can be performed by a waste department server 210, which is provided with access to the waste data.

At step 745 the server 210 scheduling the waste collection determines an available receptacle volume, typically based on a receptacle volume of the receptacles in the geographic area, and an expected volume of waste accumulated since the receptacles were last emptied. This information is then used by the server 210 to determine a predicted waste fill time at step 750.

At step 755 a location of geographic area relative to the waste collection facility is determined, with this being used to determine a zone travel time at step 760 based on the distance of the geographic area from the waste collection facility, traffic information at the predicted fill time or the like. This is then used to schedule waste collection time at step 765. At step 770 it is determined if the geographic areas are complete and if not the process returns to step 700 allowing a next geographic area to be selected.

Accordingly, the above described system provides a mechanism for allowing transaction details to be used to assist in scheduling waste services. In one example, this is achieved using a combination of two models, including using a clustering model to segregate a region, such as a city into various geographic areas, and a second model to determine when the waste load in a particular region will be high/almost full and needs cleaning. This process allows waste management facilities to plan waste collection trips in a more effective manner, thereby minimizing waste collection requirements, whilst avoid overfill scenarios.

In order to identify the geographic areas, in one example a clustering algorithm is used to cluster waste receptacles based on a number of parameters, including but not limited to a geographical location of individual waste receptacles throughout the region, demographic factors such as a population density and/or household income and a presence of factories and/or other major industries.

For scheduling the waste collection time, a multivariate analysis can be performed and the variables that can be considered include an amount of spend and spend by industries in that area as obtained from transaction details, an indication of items bought by people, information regarding travel patterns, including people travelling to or from a geographic area, a buying behavior of people travelling to or from the geographic area and a time pattern of purchase behavior of people.

This enables the model to be used to help in identifying the ideal time at which people from waste department should depart the facility in order to reach the geographic area, taking into account the location of the area, a type of waste collection used and an amount of traffic that may be present at that time.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A method for use in scheduling waste services, the method including, in at least one processing device:
obtaining transaction details indicative of transactions between consumers and merchants;
using the transaction details to determine predicted waste volumes within each of a number of geographic areas; and
generating waste data indicative of the predicted waste volumes in each geographic area, the waste data being used in scheduling waste services.

2. A method according to claim 1, wherein the transaction details are indicative of a transaction amount, and wherein the method includes determining the predicted waste levels using the transaction amount.

3. A method according to claim 2, further comprising:
determining an industry type associated with the merchant;
using the industry type to determine an industry waste level; and
using the transaction amount and industry waste level to determine the predicted waste levels for the respective transaction,
wherein the transaction details are indicative of a merchant, and wherein the method includes determining the predicted waste levels using the merchant.

4. A method according to claim 3, wherein the method includes:
analyzing merchant sales data indicative of historical sales of items by merchants of a respective industry type to determine item sale patterns; and
using the item sales patterns and item data indicative of a waste amount associated with each of a plurality of items to determine the industry waste level for merchants of the respective industry type.

5. A method according to claim 1, wherein the method includes:
determining item purchase data indicative of a purchased item; and
determining predicted waste levels at least in part using the item purchase data.

6. A method according to claim 5, wherein the item purchase data is indicative of at least one of an item identity and item type, and wherein the method includes determining the predicted waste levels using item waste data indicative of a waste amount associated with each of a plurality of items or item types.

7. A method according to claim 1, wherein the method includes:
determining a predicted waste type; and
determining the predicted waste volumes in one or more geographic areas using the predicated waste type.

8. A method according to claim 7, wherein the method includes:
determining a predicted waste amount; and
using the predicted waste amount and the predicted waste type to determine a predicted waste volume.

9. (canceled)

10. A method according to claim 1, wherein the method includes:
determining a predicted waste location;
determining the predicted waste volumes in one or more geographic areas using the predicated waste location; and
determining a predicted waste location at least one of:
i. based on a merchant location of the merchant;
ii. based on a customer location of the customer;
iii. travel patterns of customers; and
iv. disposal patterns of customers.

11. A method according to claim 1, wherein using the transaction details to determine predicted waste volumes in each geographic area comprises: using a multivariate time series analysis, the analysis being performed in a respective geographic area depending on at least one of:
a) an amount of spend by industry type;
b) purchased items;
c) buying behavior of consumers; and
d) a time pattern of purchase behavior.

12. A method according to claim 11, wherein the method is performed using a vector autoregression model.

13. (canceled)

14. A method according to claim 1, wherein the transaction details are obtained from at least one of the following devices:
a) a Point of Sale (POS) device;
b) a merchant processing device;
c) an acquirer processing system; and
d) a client device.

15. A method according to claim 1, further comprising:
using the waste data to schedule a waste collection time;
determining an available waste receptacle volume in the geographic area;
using the available waste receptacle volume and the waste volumes to determine a predicted receptacle fill time;
using the predicted receptacle fill time to schedule the waste collection time; and
determining an available waste receptacle volume in the geographic area based on a known receptacle volume and a duration since last the receptacles were last emptied.

16. A method according to claim 15, wherein using the available waste receptacle volume and the waste volumes to determine the predicted receptacle fill time comprises:
determining an available waste receptacle volumes for different types of waste;
determining a predicted waste volume for different types of waste; and
using the available waste receptacle volume and the waste volumes to determine a predicted receptacle fill time for different types of waste receptacle.

17. A method according to claim 15, wherein the method includes determining the predicted receptacle fill time using an analysis of high/almost full waste loads.

18. A method according to claim 15, wherein the available waste receptacle volume is based on at least one of:
a) a number of waste disposal bins;
b) a size of waste disposal bins; and
c) a type of waste disposal bins.

19. A method according to claim 1, wherein the method includes determining a geographic area by grouping a plurality of waste receptacles.

20. A method according to claim 19, wherein the plurality of waste receptacles are grouped according to at least one of:
a) geographical location of waste disposal resources;
b) population density;
c) household income;
d) presence of industry and/or major industries; and
e) other demographic factors.

21. A method according to claim 19, wherein the method of grouping a plurality of waste receptacles is performed using k-means clustering.

22. A system for use in scheduling waste services, the system including at least one processing device that:
obtains transaction details indicative of transactions between consumers and merchants;
uses the transaction details to determine predicted waste volumes within each of a number of geographic areas; and
generates waste data indicative of the predicted waste volumes in each geographic area, the waste data being used in scheduling waste services.
